(19) United States
(12) Patent Application Publication
(10) Pub. No.: US 2025/0299598 A1
(43) Pub. Date: Sep. 25, 2025

(54) METHOD OF TEACHING THE GAME OF CHESS USING 3 CHESS PIECES

(71) Applicant: Eladio Alameda, Orange Park, FL (US)

(72) Inventor: Eladio Alameda, Orange Park, FL (US)

(21) Appl. No.: 19/076,086

(22) Filed: Mar. 11, 2025

Related U.S. Application Data
(60) Provisional application No. 63/568,641, filed on Mar. 22, 2024.

(51) Int. Cl. G09B 19/22; A63F 3/02

(52) U.S. Cl. CPC G09B 19/22; A63F 3/02

(57) ABSTRACT

A game or method of teaching a modified chess game may include providing a chessboard having sixty-four squares arranged in eight columns and eight rows; providing first and second sets of game pieces corresponding respectively to first and second players, the first and second sets of game pieces each including a king, two knights, and eight pawns; and instructing a player on how to use the king, the two knights, and the eight pawns; and introducing one additional game piece to each of the first and second sets of game pieces only after mastering the king, the two knights, and the eight pawns through multiple games, wherein the game ends when a pawn reaches rows 1 or 8, and if both players lose all the pawns, the game is a draw.

### CROSS-REFERENCE TO RELATED APPLICATIONS

The present application claims priority to U.S. Provisional Application No. 63/568,641 filed Mar. 22, 2024, titled “THE 3-PIECE PAWN GAME,” which is hereby incorporated by reference in its entirety.

### TECHNICAL FIELD

The embodiments generally relate to the technical field of systems and methods of teaching the game of chess, specifically providing a structured approach that simplifies the learning process by introducing pieces incrementally to facilitate mastery of fundamental gameplay concepts.

### BACKGROUND

Chess is a complex game that requires players to understand the movements, interactions, and strategic applications of multiple pieces simultaneously. Traditional methods of instruction typically introduce all pieces and their respective movements at once, which can overwhelm beginners and create a steep learning curve. Many new players struggle to grasp the fundamentals, leading to frustration and discouragement before they can develop an appreciation for the game. Additionally, conventional training methods often assume a base level of familiarity with chess, making it difficult for absolute beginners to engage effectively.

While various instructional tools, including books, online tutorials, and interactive applications, exist to aid chess education, most still require players to learn the game in its entirety from the outset. Some digital platforms offer guided exercises, but they do not fundamentally change the structure of how chess is taught. As a result, these tools often fail to address the core issue of cognitive overload for new learners. Without a structured and progressive introduction to chess mechanics, many players abandon their efforts before achieving proficiency.

The disclosed system provides an alternative approach by initially limiting gameplay to three types of pieces—kings, knights, and pawns—before gradually introducing additional pieces as the player develops a deeper understanding of movement and strategy. By simplifying the learning process, players can engage with the game in a more manageable and intuitive manner. This method allows beginners to focus on core decision-making skills without the distraction of complex piece interactions, ultimately fostering a more enjoyable and effective learning experience.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

A system and method for teaching chess simplifies the learning process by initially limiting gameplay to a subset of chess pieces, specifically kings, knights, and pawns. Players first learn to play the game using only these pieces, allowing them to focus on fundamental movements, strategy, and decision-making before additional complexity is introduced. Once a player demonstrates proficiency with these pieces, additional chess pieces may be gradually introduced in a structured manner.

The structured approach of this teaching method allows beginners to engage with chess in a more accessible and intuitive manner. Instead of immediately requiring players to understand the movement and interactions of all pieces, the method progressively builds knowledge, ensuring that each concept is reinforced before introducing new mechanics. Players become familiar with core strategic elements such as positioning, piece coordination, and pawn structure without being overwhelmed by the full complexity of the game.

The method further incorporates a rule variation to provide a clear and manageable objective, allowing a game to end when a pawn reaches the opponent's first or eighth row. Additionally, if both players lose all their pawns, the game results in a draw. This modification creates a straightforward victory condition that helps new players grasp strategic play and goal-oriented thinking.

As players develop confidence and proficiency, additional pieces, such as bishops, rooks, and queens, may be introduced incrementally. Each new piece is added only after mastery of the previous stage, ensuring that players fully understand and integrate each component before progressing. This phased learning model reduces cognitive overload and enables a smoother transition to full-game chess play.

By modifying the traditional approach to chess instruction, this system provides a more effective and engaging way for new players to learn the game. The structured progression, simplified early-game mechanics, and clear learning objectives facilitate faster comprehension and greater retention of fundamental chess principles, making the game more accessible to a broader audience.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates method of teaching a modified chess game, according to some embodiments;

FIGS. 2A-2D illustrate method of teaching a modified chess game, according to some embodiments; and

FIG. 3 illustrates method of teaching a modified chess game, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The disclosed system provides a method for teaching chess that introduces gameplay in a progressive manner by initially limiting the number of pieces used. The method utilizes a standard chessboard with sixty-four squares arranged in an eight-by-eight grid and a modified set of chess pieces consisting of a king, two knights, and eight pawns for each player. This setup allows new players to engage with the game using a simplified set of rules and piece movements before additional complexity is introduced. The method may be implemented using physical chess sets, digital chess platforms, or interactive teaching tools.

The chessboard used in this method may be a conventional chessboard with alternating light and dark squares, providing a familiar playing surface. The reduced set of pieces allows players to focus on fundamental gameplay mechanics, such as movement, capturing, and positioning, without being overwhelmed by the full range of chess piece interactions. The arrangement of the pieces at the beginning of the game may follow standard chess positioning, with the king and knights placed in their conventional starting squares, and the pawns positioned in a single row in front of them.

Each piece in the modified set retains its traditional movement rules. The king may move one square in any direction, including diagonally. The knights may move forward, sideways, and backwards in an L-shaped pattern, jumping over other pieces as needed. The pawns may move forward one square at a time but capture diagonally. The method encourages players to develop a solid understanding of these movements through repeated gameplay before additional pieces are introduced.

The game may be played using modified win conditions designed to provide clear and achievable objectives. A game may conclude when a player moves a pawn to the opponent's first or eighth rank, reinforcing strategic thinking and pawn advancement principles. Alternatively, if both players lose all their pawns, the game may result in a draw. These conditions simplify the learning process while maintaining the strategic depth of chess.

Once players demonstrate proficiency with the initial set of pieces, additional chess pieces may be introduced incrementally. A bishop may be added to each player's set once they have mastered the movement and use of kings, knights, and pawns. The bishop moves diagonally across squares of the same color, allowing players to explore long-range movement and piece coordination. Players may practice with the new configuration before proceeding to additional stages.

After mastery of the bishop, a rook may be introduced. The rook moves horizontally and vertically across the chessboard, expanding the player's understanding of linear movement and piece synergy. Gameplay with the rook included may reinforce control of open files and ranks, a fundamental aspect of full-game chess strategy.

The final piece to be introduced is the queen, which combines the movement abilities of both the bishop and the rook. The queen's inclusion allows players to experience the full complexity of chess while building upon their foundational knowledge. Each stage of progression ensures that players are prepared for the next level of gameplay, preventing cognitive overload and fostering gradual improvement.

The method may incorporate structured instructional techniques, such as guided exercises, practice drills, and knowledge checks. These instructional components may be used to assess a player's readiness to progress to the next stage. Digital implementations of this method may provide interactive tutorials, real-time feedback, and adaptive difficulty adjustments based on player performance.

The disclosed system may be used in various educational settings, including classrooms, chess clubs, and self-directed learning environments. It may be adapted for one-on-one instruction, group lessons, or independent study. Additionally, it may be used as a tool for reinforcing strategic thinking and decision-making skills beyond chess itself.

By structuring chess education in a progressive manner, the disclosed system provides a method that enables players to develop confidence and competence in chess gameplay. Through incremental introduction of chess pieces and simplified game conditions, new players may achieve a better understanding of chess mechanics while gradually advancing to full-game play.

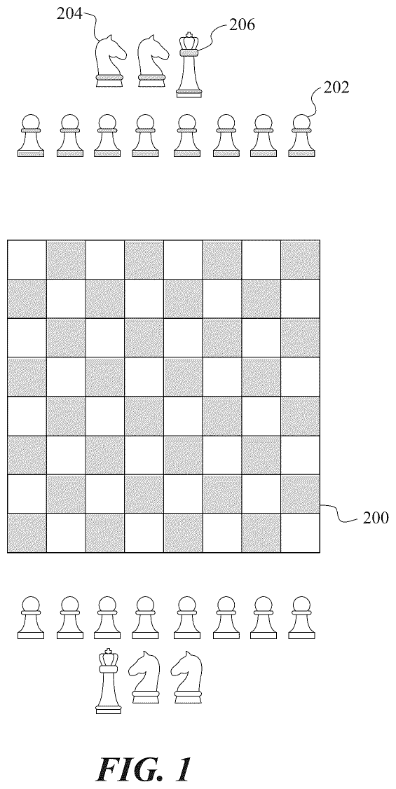

FIG. 1 illustrates method of teaching a modified chess game including a standard chessboard 200 having sixty-four squares arranged in eight columns and eight rows. The method may include first and second sets of game pieces corresponding respectively to first and second players, the first and second sets of game pieces each consisting of a king 206, two knights 204, and eight pawns 202.

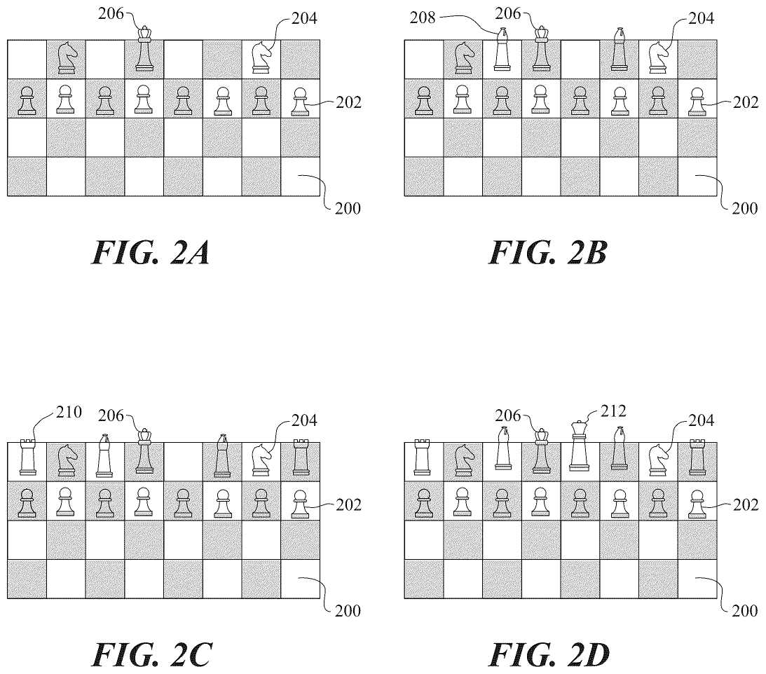

FIGS. 2A-2D illustrate method of teaching a modified chess game. The method may include, depicted in FIG. 2A, providing a chessboard 200 having sixty-four squares arranged in eight columns and eight rows; providing first and second sets of game pieces corresponding respectively to first and second players, the first and second sets of game pieces each comprising a king 206, two knights 204, and eight pawns 202. The method may include instructing a player on how to use the king 206, the two knights 204, and the eight pawns 202 and introducing one additional game piece to each of the first and second sets of game pieces only after mastering the king 206, the two knights 204, and the eight pawns 202 through multiple games, wherein the game ends when a pawn 202 reaches rows 1 or 8, and if both players lose all the pawns, the game is a draw.

FIG. 2B depicts a second step in the method, wherein the step includes instructing a player on how to use a bishop 208 introduced to the modified chess game.

FIG. 2C depicts a third step in the method, wherein the step includes instructing a player on how to use a rook 210 after mastering the movement of the bishop 208.

FIG. 2D depicts a fourth step in the method, wherein the step includes instructing a player on how to use a queen 212 after mastering the movement of the rook 210 and bishop 208.

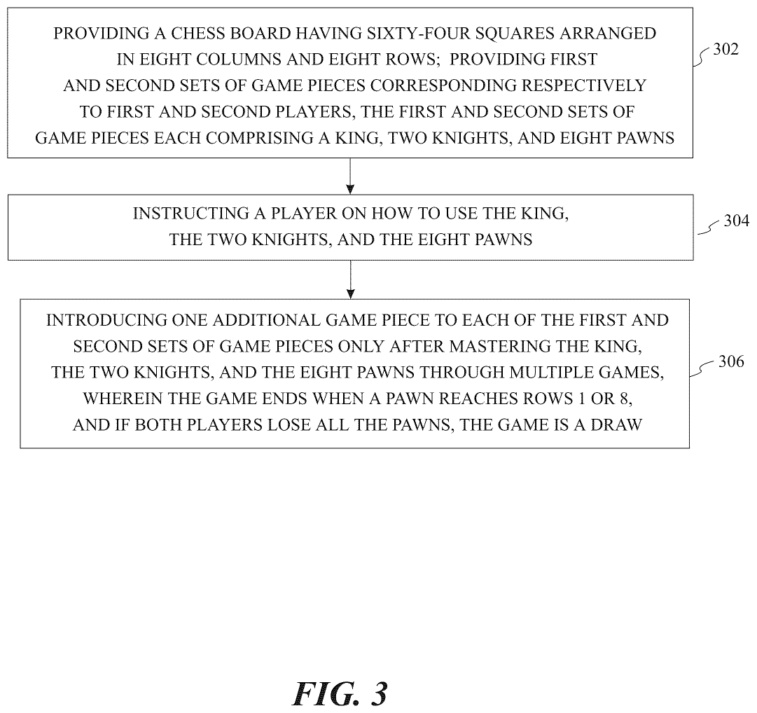

FIG. 3 illustrates method of teaching a modified chess game. The method may include, in step 302, providing a chessboard having sixty-four squares arranged in eight columns and eight rows; providing first and second sets of game pieces corresponding respectively to first and second players, the first and second sets of game pieces each comprising a king, two knights, and eight pawns. Step 304 may include instructing a player on how to use the king, the two knights, and the eight pawns. Step 306 may include introducing one additional game piece to each of the first and second sets of game pieces only after mastering the king, the two knights, and the eight pawns through multiple games, wherein the game ends when a pawn reaches rows 1 or 8, and if both players lose all the pawns, the game is a draw.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A chess game consisting of:
a chessboard having sixty-four squares arranged in eight columns and eight rows; and first and second sets of game pieces corresponding respectively to first and second players, the first and second sets of game pieces each consisting of a king, two knights, and eight pawns.

2. A method of teaching a modified chess game, the method comprising:
providing a chessboard having sixty-four squares arranged in eight columns and eight rows; providing first and second sets of game pieces corresponding respectively to first and second players, the first and second sets of game pieces each comprising a king, two knights, and eight pawns;
instructing a player on how to use the king, the two knights, and the eight pawns; and
introducing one additional game piece to each of the first and second sets of game pieces only after mastering the king, the two knights, and the eight pawns through multiple games, wherein the game ends when a pawn reaches rows 1 or 8, and if both players lose all the pawns, the game is a draw.

3. The method of claim 2, further comprising instructing a player on how to use a bishop.

4. The method of claim 3, further comprising instructing a player on how to use a rook after mastering the movement of the bishop.

5. The method of claim 4, further comprising instructing a player on how to use a queen after mastering the movement of the rook and bishop.

6. The method of claim 2, further comprising performing knowledge checks to confirm learning progression of the player prior to introducing one or more additional game pieces to each of the first and second sets of game pieces.

7. The method of claim 2, wherein the game is played using a modified rule set that restricts piece movements or actions to emphasize specific strategic concepts before additional pieces are introduced.

8. The method of claim 2, wherein the chessboard is implemented as a digital interface, and the method further comprises providing interactive tutorials that guide players through each stage of piece introduction.

9. The method of claim 2, further comprising using a scoring or ranking system to track player progress through the incremental learning stages.

10. The method of claim 2, further comprising adapting the timing of piece introductions based on the player's demonstrated proficiency, determined through in-game performance metrics.

11. The method of claim 2, wherein a training mode is provided that simulates common chess scenarios using only the available pieces to reinforce specific strategic concepts.

12. The method of claim 2, wherein the method is implemented in a classroom or group learning environment, and further comprises structuring lessons around the incremental piece introduction process.

13. The method of claim 2, wherein players are provided with guided exercises focusing on fundamental chess principles, such as controlling the center, piece coordination, and defensive positioning, before additional pieces are introduced.

14. The method of claim 2, further comprising integrating real-time feedback that suggests optimal moves and strategies during gameplay to reinforce learning objectives.
